(19) United States
(12) Patent Application Publication
(10) Pub. No.: US 2013/0021228 A1
(43) Pub. Date: Jan. 24, 2013

(54) PIXEL CIRCUIT AND DISPLAY DEVICE

(71) Applicants: Koichi Miwa, Yokohama-shi (JP); Yuichi Maekawa, Shagamihara-shi (JP)

(72) Inventors: Koichi Miwa, Yokohama-shi (JP); Yuichi Maekawa, Shagamihara-shi (JP)

(73) Assignee: GLOBAL OLED TECHNOLOGY LLC, Wilmington, DE (US)

(21) Appl. No.: 13/513,157

(22) PCT Filed: Nov. 30, 2010
(86) PCT No.: PCT/US10/58268

§ 371 Date: Oct. 12, 2012

(30) Foreign Application Priority Data
Dec. 2, 2009 (JP) 2009-274198

(51) Int. Cl. G09G 3/30

(52) U.S. Cl. 345/76

(57) ABSTRACT

[Problem to be solved] To achieve low power consumption. [Solution] The driving transistor T1 supplies driving current from the power supply VDD to the organic EL elements OLED. The source end of the driving transistor T1 connected to one end of the said organic EL elements OLED, the other end of the organic EL elements OLED is connected to the power supply potential Vss, and the mutual conductance per display unit area of the said organic EL elements of the said driving transistor is equal to or higher than 1×10⁻¹¹ (A/V²/m²).

### TECHNICAL FIELD

The present invention relates to a pixel circuit using self-emissive elements and its display device.

### BACKGROUND ART

Recently, organic EL displays are being developed actively, making a remarkable progress. A display using self-emissive elements such as organic EL is superior in viewing angle characteristics and contrast, indicating excellent display characteristics.

Organic EL displays are driven by a passive method or an active method. For a display with a large screen, high definition, and high refresh rate, mainly an active method is used because organic EL elements tend to deteriorate when used in a high current density. An active matrix driving system is broadly divided into an analog driving system and a digital driving system.

A constitution of FIG. 1 is employed, for example, as a pixel circuit of an analog driving system. A P-channel is employed as a P-channel driving transistor (TFT) T1 with the source being connected to a power supply VDD and a retentive capacitance Cs being arranged between the gate and the source. Also the drain of the driving transistor T1 is connected to a power supply CV through organic EL elements OLED. A data signal Vdata is supplied from a data line to the gate of the driving transistor T1 through a switch SW. Basically, the organic EL elements OLED is connected to the train of the driving transistor T1.

A signal voltage Vdata based on luminance gradation is applied to the gate of the driving transistor T1, the signal voltage Vdata is retained by the retentive capacitance Cs for a period of 1 frame, and pixel current based on the signal voltage Vdata is supplied to the organic EL elements OLED.

The pixel current is controlled by the voltage between the gate and source Vgs (VDD−Vdata) of the driving transistor T1 which is driven in a saturated region. Normally, the driving voltage of an organic EL is about 3V to 10V, but about 5V is needed additionally as power supply voltage because the driving transistor T1 is operated in a saturated region.

FIG. 2A indicates the relationship between the train Va of the driving transistor T1 and train current as well as the relationship between an applied voltage Va of the organic EL elements LED and current holed of the organic EL elements. Once Vgs is determined, driving current is determined in relation to Vds. Thus, Va and holed are determined at the intersection of characteristics selected by Vgs and Voled. As mentioned above, the driving transistor T1 is used in a saturated region and its Vds=VDD−Va becomes a fairly large value.

Generally, polysilicon or amorphous silicon is used for a driving TFT. Polysilicon has characteristic variation originated from inhomogeneous crystal grains while amorphous silicon has threshold shift accompanied with drive, and in analog driving system, the driving current of organic EL elements is affected by the characteristics of driving TFT and causes luminance variation in pixels.

Therefore, in analog driving system, a method of driving pixel circuit which compensates for threshold voltage variations of driving TFT is proposed (refer to patent reference 1).

On the other hand, in a digital driving system, the driving TFT functions as a simple switch and the luminance gradation is realized by time-sharing drive. One frame period is divided into a plurality of sub frames and light emission and non light emission in each sub frame is controlled based on display gradation.

The driving TFT operates in a linear region with digital driving system. Thus, as indicated in FIG. 2B, the voltage between drain and source Vds is low compared to the driving voltage Voled of the organic EL elements OLED (the difference between Va and VDD is Vds). Therefore, it is not easily affected by characteristic variation of driving TFT compared to analog driving system, and it has an advantage of making power consumption low.

On the other hand, current density becomes high while light is emitting because luminance gradation is controlled by light emitting time. Thus one frame needs to be divided into sub frame based on display gradation. Moreover, there is a limit to dividing into sub frames, and it becomes difficult to realize high gradation expression and high resolution expression. Therefore, a driving method which comprises a data erasing TFT in addition to a data writing TFT and neighboring sub frames are temporarily overlapped is proposed (see patent reference 2).

Also, deterioration of organic EL elements is generally progressed in a speed proportional to about the 1.5th to 1.7th power of current density. In digital driving system, gradations are expressed by time-sharing drive and the current density while light is emitting, making it relatively easier for organic EL elements to deteriorate. Moreover, in accordance with deterioration by drive, the driving voltage of the organic elements tends to become higher, and decrease of pixel luminance becomes greater in digital driving system which is a constant voltage driving system.

### PRIOR ART REFERENCES

### Patent References

[Patent Reference 1] Japanese Published Unexamined Application No. 2007-310034
[Patent Reference 2] Japanese Published Unexamined Application No. 2001-343933

### GENERAL DESCRIPTION OF THE INVENTION

### Problems to be Solved by the Invention

As explained above, power consumption becomes higher in analog driving system compared to digital driving system, but digital driving system has following problems and it cannot be applied widely. One the other hand there is a high demand for an organic EL display with low power consumption, and a low-power-consumption driving system is highly anticipated.

### Means for Solving the Problems

A pixel circuit according to the present invention comprising organic EL elements and a driving transistor for supplying current from a power supply to the said organic EL elements, wherein a source end of the said driving transistor is connected to one end of the said organic EL elements, the other end of the said organic EL elements is connected to a power supply potential, characterized in that mutual conductance per display unit area of the said organic EL elements of the said driving transistor is equal to or higher than 1×10⁻¹¹ (A/V²/m²).

It is preferred that the mutual conductance of the said driving transistor is made higher by satisfying one of the followings: a channel capacitance is made larger when the mobility of the driving transistor is equal to or greater than 15 cm² Vs with the gate voltage equal to or less than 20V; or the thickness of a gate insulator of the driving transistor is equal to or less than 1000 angstrom; or the light from the said organic EL elements transmit to the driving transistor with a maximum wavelength transmittance of 70% or higher against the channel layer of the driving transistor or against visible light of the source electrode and also the driving transistor is made larger.

Also, the driving transistor is a thin-film transistor (TFT) and it is preferred that the channel layer of the driving TFT is formed with polysilicon or amorphous silicon or microcrystalline silicon or oxide semiconductor.

It is preferred that the threshold voltage of the driving TFT or turn on voltage of the organic EL elements or their sum is added to the gradation signal voltage and applied to the gate of the driving TFT.

Also it is preferred that temperature of the organic elements is presumed from ambient temperature, temperature of the display, display image or history of display image, and a function to adjust power supply voltage which is supplied to pixels or signal voltage is included.

Also, the display device according to the present invention is characterized in that the above-mentioned pixel circuit is employed.

### ADVANTAGES OF THE INVENTION

As explained above, according to the present invention, in a display device using organic EL elements, analog drive is possible with a low power consumption.

### BRIEF DESCRIPTION OF THE DRAWINGS

FIG. 1 is a diagram illustrating a constitution of a conventional pixel circuit.

FIG. 2A is a schematic bias diagram of a conventional analog drive.

FIG. 2B is a schematic bias diagram of a conventional digital drive.

FIG. 3 is a diagram illustrating a constitution of a pixel circuit of the first embodiment.

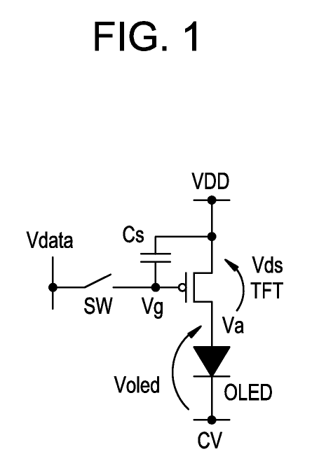

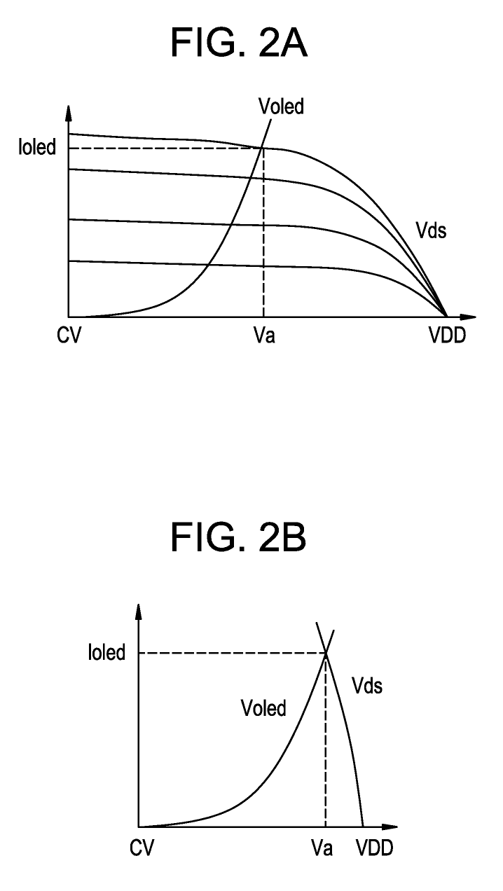

FIG. 2A is a schematic bias diagram of a drive of the first embodiment.

FIG. 5 is a diagram illustrating a constitution of a pixel circuit of the second embodiment.

FIG. 2A is a timing chart of the drive of the second embodiment.

FIG. 7 is a diagram illustrating a constitution of a modified first embodiment.

### MODE FOR CARRYING OUT THE INVENTION

An embodiment of the present invention will be explained based on the figures below.

### “Summary”

According to the display device of the embodiments, the organic EL elements are connected to the source of the driving TFT.

In general, organic EL elements are drain connected to a driving transistor (TFT), and the mutual conductance per display area of the driving transistor is designed to be around 1×10⁻¹² to 5×10⁻¹² (A/V²/m²). In this embodiment, the mutual conductance per display area of the driving transistor is equal to or more than 1×10⁻¹¹ (A/V2/m2), preferably equal to or more than 1×10⁻¹⁰ (A/V2/m2). Here, the mutual conductance of the transistor is defined as a value obtained from partially differentiating drain current with respect to gate voltage, and normally is channel electric field dependent. Therefore, the value of mutual conductance is dependent on the gate voltage applied to the transistor. Thus, by tradition, the maximum partial differentiation of gate voltage of the drain current within an appropriate gate voltage is employed as a mutual conductance value.

Consequently, the voltage necessary between the gate and source of the driving transistor is equal to or less than 1V, preferably equal to or less than 0.4 which is low enough compared to the driving voltage of the organic EL elements. Thus, the voltage between the drain and source necessary to have the driving transistor operated in the saturated region is a fraction of the driving voltage of the organic EL elements, preferable equal to or less than 1/10.

As explained above, according to this embodiment, in a conventional analog driving system, the power supply voltage can be reduced by 30% to 60% compared to the case when approximately 5V is necessary for the drain and source voltage of the driving transistor and power consumption can be reduced.

In a digital driving system, it was difficult to correct luminance when an increase of driving voltage is large due to deterioration of organic EL element. This embodiment is an analog driving system and it is relatively easy to add increased driving voltage of the organic EL elements to the gate of the driving transistor in a pixel circuit.

To carry out this embodiment, it is necessary to use a transistor with a high mutual conductance. The method of increasing mutual conductance includes: increase channel mobility, lower channel capacitance, make the ratio of channel width and length greater etc.

The easiest method to increase the mutual conductance of a driving transistor made of TFT is to increase channel mobility. TFT channel materials with high mobility include: polysilicon (ELA (Excimer Laser Anneal) method, SPC (Solid Phase Crystallization) method and Laser anneal method), and oxide semiconductor (ZnO, IGZO, IZO, ZTO etc.) In this case, the mobility is equal to or greater than 15 cm²/Vs, preferably equal to or greater than 20 cm²/Vs.

Polysilicon is preferred for the driving transistor of this embodiment because the mobility of carriers is high. In general, it is preferred that contact is formed on the cathode of organic EL elements or, on a contrary, organic EL elements are formed by accumulating from cathode in because polysilicon forms P-channel

Also, oxide semiconductor is preferred because it generally forms N-channel and its motility is high. Oxide semiconductor is preferred for superiority in uniform initial characteristic and stability of bias applying elements. Especially, when mobility is high enough or the ratio of channel width and channel length can become greater using transparent electrodes and channel, oxide semiconductor is preferred because the gate voltage can be made low and the electrical field applied to the gate can be made minimum to control deterioration of driving transistor due to bias stress.

The mutual conductance of the driving transistor can be increased by increasing channel capacitance. As the method of increasing the channel capacitance, it is preferred that laminating method such as chemical vapor deposition (CVD) method and atomic layer deposition (ALD) method are used to form gate insulators. It is preferred that the thickness of the gate insulator is equal to or less than 1000A (angstrom), preferably equal to or less than about 500A.

The mutual conductance of the driving transistor can be increased by increasing the ratio of channel width and channel length of the driving transistor. There is a limitation to shortening channel length considering the processing accuracy and yeild and therefore it is achieved mainly by widening the TFT channel width.

In order to increase the size of the driving transistor, it is preferred to widen the channel width while securing luminance area of the organic EL elements. Therefore, it is prefeered to have a top emission structure which extracts emission of organic EL elements to an opposite side of the TFT substrate in which TFT such as driving transistors are arranged.

Also, when a bottom emission structure is used, it is preferred that light is passed through a part of TFT by overlapping a part of a driving transistor and organic EL luminance area using transparent electrodes and transparent channel. In this case, it is preferred that the maximum wavelength transmittance against the visible light of the transparent channel and electrode is equal to or greater than 70%. More preferably, equal to or greater than 70% for almost an entire area of visible light and the maximum wavelength transmittance against the visible light is equal to or greater than 80%. As a result, pixels with a sufficient aperture ratio are maintained even when the driving transistor is made larger by widening the channel width of the driving transistor.

The IV characteristic of a source follower circuit using organic EL elements as a load is dependent on the characteristics of organic EL elements. Especially, organic EL elements depend strongly on temperature and IV characteristics of the pixel circuit to which the present invention is applied depend strongly on operation temperature. Therefore, it is preferred to include a function for adjusting power supply voltage or signal voltage based on display temperature, ambient temperature, and display content to correct temperature dependency of pixel circuit IV based on the temperature dependency of the organic EL elements That is, the temperature of the organic EL elements can be estimated by measuring display temperature and environmental temperature (ambient temperature). Also, the temperature of the organic EL elements can be estimated based on the results of estimating the display current from history of image data content (display content). Also, based on the estimated temperature of the organic EL elements obtained as such, it becomes possible to compensate for variations of driving current of the organic EL elements (=light−emission luminance) based on variation in temperature by adjusting power supply voltage and signal voltage.

### Embodiment 1

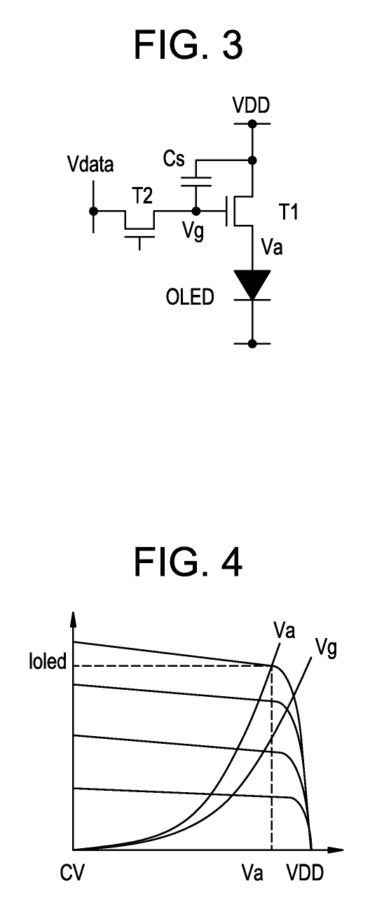

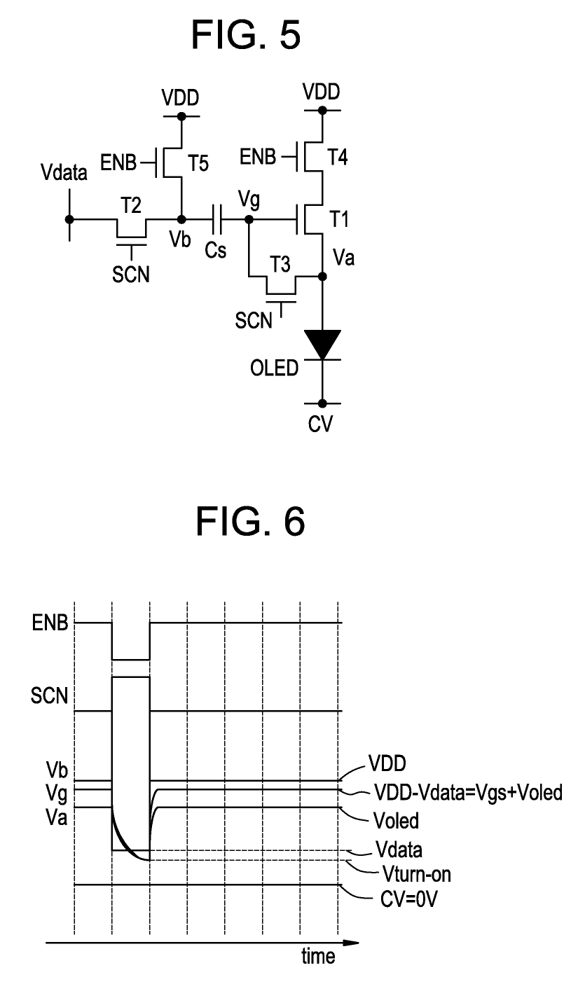

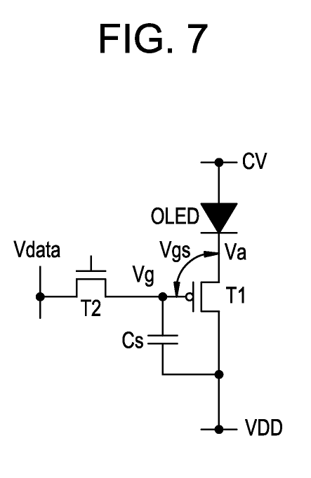

FIG. 3 is a configuration diagram of the pixel circuit according to the first embodiment of the present invention. It is constituted with 2 TFTs and a retentive capacitance.

A drain of a N-style driving transistor (TFT) T1 is connected to a power supply VDD and a gate is connected to a signal line via a writing transistor (TFT) T2. A retentive capacitance Cs is connected to between the gate and train of the N-style driving transistor T1. An anode of an organic EL elements OLED is connected to the source of the driving transistor T1, and its cathode is connected to a power supply CV.

The operation of the circuit of the first embodiment will be explained in details below. The circuit of FIG. 3, as in the conventional pixel circuits, supplies driving current based on the target luminance from the driving transistor T1 to the organic EL elements OLED by applying singal voltage Vdata from the signal line to the gate of T1. However, in the circuit of FIG. 3, the organic EL elements OLED is connected to the source side of the driving transistor T1 to form a so-called source follower circuit, and the voltage Vg applied to the gate becomes the sum of the gate and source voltage Vgs of the driving transistor T1 which is required to supply the driving current of the organic EL elements OLED and the driving voltage Voled of the organic EL elements OLED itself (Vgs=Vgs+Voled).

Here, when the mutual conductance of the driving transistor T1 is made equal to or greater than 1×10⁻¹¹ (A/V²/m²), preferably equal to or greater than 1×10⁻¹⁰ (A/V²/m²), the Vgs of the driving transistor T1 which is necessary to drive the organic EL elements OLED normally becomes equal to or less than 1V.

For example, if the organic EL display has an 8-bit gradation, the signal voltage needs to be controlled with 256 gradations in an analog driving system. If the driving range of the driving transistor T1 becomes smaller, it becomes difficult to control gradations accurately. According to this embodiment, gradation voltage can be controlled accurately even with the driving transistor T1 with a high mutual conductance by controlling the voltage obtained from adding the driving voltage of the organic EL elements OLED.

FIG. 4 is an example of an operation bias of the circuit of the first embodiment. A curve Va indicates the relationship between the variation of anode potential Va of the organic EL elements OLED and the current 101ed which flows to the organic EL elements, and a curve Vg indicates the relationship between the gate voltage Vg of the driving transistor T1 and its current 101ed which is applied at the moment. The difference between the gate voltage Vg of the driving transistor of FIG. 4 and the anode voltage (=the source voltage of the driving transistor T1) of the organic EL elements OLED corresponds to the Vgs of the driving transistor T1, because the current of the driving transistor T1 and of the organic EL elements OLED are the same. Also, FIG. 4 indicates the current value which is applied to the driving transistor T1 when the Vgs of the driving transistor T1 is made a constant value and its source potential is modified.

Because the mutual conductance of the driving transistor T1 is high and the Vgs of the driving transistor is relatively small, the train and source voltage Vds does not need to be large to operate the driving transistor T1 in a saturated region. When FIG. 4 is compared to the operation bias of the prior art indicated in FIG. 2A, it becomes clear that the power supply voltage VDD-CV is suppressed. That is, a driving current Voled can be modified by Vgs, but Vds=VDD−Va can be relatively small, allowing the VDD to be a relatively low voltage.

Also, it is expected that the threshold voltage shift can be kept to a minimum when microcrystalline silicon or oxide semiconductor is used as the driving transistor T1, because the gate bias of the driving transistor T1 is kept low. Thus, a conventional problem such as elements deterioration which is caused by using such semiconductor in a driving TFT can be solved.

### Embodiment 2

When the resistance of the organic EL elements OLED is increased by driving, it is effective to offset the driving voltage Voled of the organic EL elements OLED for increased turn on voltage after deterioration. As the second embodiment, a circuit comprising a function of adding turn on voltage of the organic EL elements to the gate of the driving TFT is included.

FIG. 5 is a circuit diagram of the second embodiment, FIG. 6 is its driving timing chart. To simplify, the cathode potential CV of the organic EL elements OLED is considered as 0.

A transistor T4 is arranged between the drain of the driving transistor T1 and the power supply VDD, and the retentive capacitance Cs is arranged between the gate of the driving transistor T1 and the writing transistor T2. Also, a transistor T3 is arranged between the gate and source of the driving transistor T1, and the connecting point of the writing transistor T2 and the retentive capacitance is connected to the power supply VDD through a transistor T5. Transistors T4,T5 are turned on and off by a signal ENB, and the transistor T3 is turned on and off by the same signal, SCN, as the transistor T2.

The signal ENB is set to low level, the signal SCN is set to high level when the signal voltage is rewritten. As a result, the transistor T4 is turned off and the voltage of both ends of the organic EL elements OLED goes down to stop emitting light. At this time, the anode potential Va of the organic EL elements OLED becomes a turn on voltage Vturn-on. Vturn-on is introduced to the gate of the driving transistor T1 by turning on the transistor T3. Vturn-on is introduced to the gate voltage Vg by using a depression-type TFT as the driving transistor T1 because the driving transistor T1 is conductive.

At the same time, the transistor T5 is turned off and the writing transistor T2 is turned on to write signal voltage Vdata into the voltage Vb on the writing transistor T2 side of the retentive capacitance Cs. The signal voltage Vdata is expressed as below when the target gate and source voltage is Vgs:

Vdata=VDD−(Vgs−ΔVoled)

However, when the target driving voltage of the organic E1 elements is Voled, it becomes:

ΔVoled=Voled−Vturn-on

Next, when the signal ENB is set to low level, signal SCN is set to high level, the transistors T2, T3 are turned off, and the transistor T4, T5 are turned on, Vg becomes: Vgs+Voled. As a result, Vgs is applied between the gate and source of the driving transistor T1 and Voled is applied to the organic EL elements OLED to correct variation of luminance caused by the driving voltage increase ΔVoled of the organic EL elements OLED.

The mutual conductance of the transistors T1 and T5 are designed high and thus the power supply voltage VDD−CV is almost equal to the driving voltage of the organic EL elements as in the first embodiment, and the circuit of the second embodiment also operates with low power consumption.

FIG. 7 indicates a constitution of a modification of the first embodiment using a P-type TFT as the driving transistor T1 in the pixel circuit of FIG. 3. In this case, the anode of the organic EL elements is connected to the power supply CV, and the cathode is connected to the source of the driving transistor T1. The drain of the driving transistor T1 is connected to the power supply VDD and the gate is connected to the signal line through the transistor T2. Also, the retentive capacitance Cs is connected between the gate and train of the driving transistor T1. In this case, the voltage of the power supply CV is higher than that of the power supply VDD, and the current from the power supply CV flows to the organic EL elements OLED and the driving transistor T1. Also the cathode of the organic EL elements OLED is formed per pixel to make a pixel electrode and the anode becomes a common electrode to all pixels. As explained above, this constitution is suitable for polysilicon because polysilicon normally forms P-channel.

### DESCRIPTION OF THE SYMBOLS

Cs: retentive capacitance OLED: organic EL elements T1: driving transistor T2: writing transistor T3-T5: transistors.

1. A pixel circuit comprising:
organic EL elements; and
a driving transistor for supplying current from a power supply to the said organic EL elements, wherein;
a source end of the said driving transistor is connected to one end of the said organic EL elements, the other end of the said organic EL elements is connected to a power supply potential,
characterized in that mutual conductance per display unit area of the said organic EL elements of the said driving transistor is equal to or higher than 1×10⁻¹¹ (A/V²/m²).

2. The pixel circuit according to claim 1, characterized in that the mutual conductance of the said driving transistor is made higher by satisfying one of the followings:
a channel capacitance is made larger when the mobility of the driving transistor is equal to or greater than 15 cm² Vs with the gate voltage equal to or less than 20V; or
the thickness of a gate insulator of the driving transistor is equal to or less than 1000 angstrom; or the light from the said organic EL elements transmit to the driving transistor with a maximum wavelength transmittance of 70% or higher against the channel layer of the driving transistor or against visible light of the source electrode and also the driving transistor is made larger.

3. The pixel circuit according to claim 2, characterized in that
the driving transistor is a thin-film transistor (TFT) and
the channel layer of the driving TFT is formed with polysilicon or amorphous silicon or microcrystalline silicon or oxide semiconductor.

4. The pixel circuit according to claim 1 characterized in that the threshold voltage of the driving TFT or turn on voltage of the organic EL elements or their sum is added to the gradation signal voltage and applied to the gate of the driving TFT.

5. The pixel circuit according to claim 1 characterized in that the temperature of the organic elements is presumed from ambient temperature, temperature of the display, display image or history of display image, and a function to adjust power supply voltage which is supplied to pixels or signal voltage is included.

6. A display device characterized in that it comprises the pixel circuit according to claim 1.

7. The pixel circuit according to claim 2 characterized in that the threshold voltage of the driving TFT or turn on voltage of the organic EL elements or their sum is added to the gradation signal voltage and applied to the gate of the driving TFT.

8. The pixel circuit according to claim 3 characterized in that the threshold voltage of the driving TFT or turn on voltage of the organic EL elements or their sum is added to the gradation signal voltage and applied to the gate of the driving TFT.

9. The pixel circuit according to claim 2 characterized in that the temperature of the organic elements is presumed from ambient temperature, temperature of the display, display image or history of display image, and a function to adjust power supply voltage which is supplied to pixels or signal voltage is included.

10. The pixel circuit according to claim 3 characterized in that the temperature of the organic elements is presumed from ambient temperature, temperature of the display, display image or history of display image, and a function to adjust power supply voltage which is supplied to pixels or signal voltage is included.

11. The pixel circuit according to claim 4 characterized in that the temperature of the organic elements is presumed from ambient temperature, temperature of the display, display image or history of display image, and a function to adjust power supply voltage which is supplied to pixels or signal voltage is included.

12. The pixel circuit according to claim 7 characterized in that the temperature of the organic elements is presumed from ambient temperature, temperature of the display, display image or history of display image, and a function to adjust power supply voltage which is supplied to pixels or signal voltage is included.

13. The pixel circuit according to claim 8 characterized in that the temperature of the organic elements is presumed from ambient temperature, temperature of the display, display image or history of display image, and a function to adjust power supply voltage which is supplied to pixels or signal voltage is included.

14. A display device characterized in that it comprises the pixel circuit according to claim 2.

15. A display device characterized in that it comprises the pixel circuit according to claim 3.

16. A display device characterized in that it comprises the pixel circuit according to claim 4.

17. A display device characterized in that it comprises the pixel circuit according to claim 7.

18. A display device characterized in that it comprises the pixel circuit according to claim 8.

19. A display device characterized in that it comprises the pixel circuit according to claim 5.

20. A display device characterized in that it comprises the pixel circuit according to claim 9.
